(19) United States
(12) Patent Application Publication
(10) Pub. No.: US 2025/0274837 A1
(43) Pub. Date: Aug. 28, 2025

(54) Conditional Handover Configuration in a Non-Terrestrial Network

(71) Applicant: Apple Inc., Cupertino, CA (US)

(72) Inventors: Pavan Nuggehalli, San Carlos, CA (US); Naveen Kumar R. Palle Venkata, San Diego, CA (US); Ralf Rossbach, Neubiberg (DE); Fangli Xu, Beijing (CN); Sarma V. Vangala, San Jose, CA (US); Zhibin Wu, Los Altos, CA (US); Ping-Heng Kuo, London (GB); Yuqin Chen, Beijing (CN); Haijing Hu, Los Gatos, CA (US); Chunxuan Ye, San Diego, CA (US); Peng Cheng, Beijing (CN); Sethuraman Gurumoorthy, San Jose, CA (US)

(21) Appl. No.: 18/858,276

(22) PCT Filed: Jun. 8, 2022
(86) PCT No.: PCT/CN2022/097653

§ 371 Date: Oct. 18, 2024

(51) Int. Cl. H04W 36/36; H04W 36/00

(52) U.S. Cl. CPC H04W 36/362; H04W 36/0055; H04W 36/00835

(57) ABSTRACT

This disclosure relates to techniques for configuring conditional handover in a non-terrestrial wireless communication system. A wireless device and a cellular base station may establish a non-terrestrial network based wireless link. The wireless device may receive conditional handover information from the cellular base station in broadcast system information. The conditional handover information may indicate conditional handover trigger conditions for one or more candidate cells. The wireless device may evaluate the conditional handover trigger conditions. The wireless device may perform handover to a candidate cell when conditional handover to the candidate cell is triggered.

### PRIORITY INFORMATION

This application is a national stage entry of PCT Application No. PCT/CN2022/097653, entitled “Conditional Handover Configuration in a Non-Terrestrial Network,” filed Jun. 8, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for configuring conditional handover in a non-terrestrial wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc. The proliferation in wireless communication techniques and standards can encompass terrestrial networks as well as non-terrestrial networks (NTNs) such as 3GPP satellite networks.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for configuring conditional handover using broadcast system information in a non-terrestrial wireless communication system.

Conditional handover techniques may be used to improve handover robustness in a cellular communication system, such as 3GPP 5G NR. Such techniques may include a cellular base station providing a handover command in advance to reduce or avoid the potential for legacy handover failure due to measurement result transmission failure or handover command transmission failure.

In a non-terrestrial wireless communication system, it may be possible that a cellular base station can provide multiple cells via satellites, e.g., that can relay communications between the cellular base station and wireless devices served by the cellular base station. In such a system, there may be benefits to supporting techniques for broadcasting conditional handover information to wireless devices, which may, for example, allow those wireless devices to perform conditional handover (e.g., at least to other cells provided by the same cellular base station) without using dedicated signaling to configure the conditional handover. For example, such techniques may reduce the signaling burden needed to perform handover, which may be beneficial for network resource use efficiency and/or to reduce wireless device power consumption. Accordingly, techniques for broadcasting conditional handover information to wireless devices in a non-terrestrial wireless communication system are described herein.

In some instances, for example when a quasi-earth-fixed satellite cell is scheduled to change service areas, it may be possible that a relatively large number of handovers could occur from a cell within a relatively short amount of time. Accordingly, in conjunction with techniques for supporting broadcasting conditional handover information to wireless devices in a non-terrestrial wireless communication system, techniques are also described herein for mitigating the potential impact of such a scenario, for example by broadcasting random access channel configuration information associated with the conditional handover information, which may help manage random access channel resource use by wireless devices in the cell in such a manner as to mitigate the potential for random access channel collisions and handover failures, at least according to some embodiments.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a network infrastructure diagram illustrating aspects of an exemplary 3GPP satellite network deployment, according to some embodiments;

FIGS. 6-7 are schematic diagrams illustrating possible interworking between 3GPP terrestrial and satellite radio access networks (RANs), according to some embodiments; and

FIG. 8 is a flowchart diagram illustrating aspects of an exemplary possible method for configuring conditional handover in a non-terrestrial wireless communication system, according to some embodiments; and

FIGS. 9A-9B illustrate signal flow aspects of an exemplary dedicated signaling scheme for configuring conditional handover for a wireless device, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
NTN: Non-terrestrial Network
TX: Transmission/Transmit
RX: Reception/Receive
RAT: Radio Access Technology
TRP: Transmission-Reception-Point
TA: Timing Advance
DCI: Downlink Control Information

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

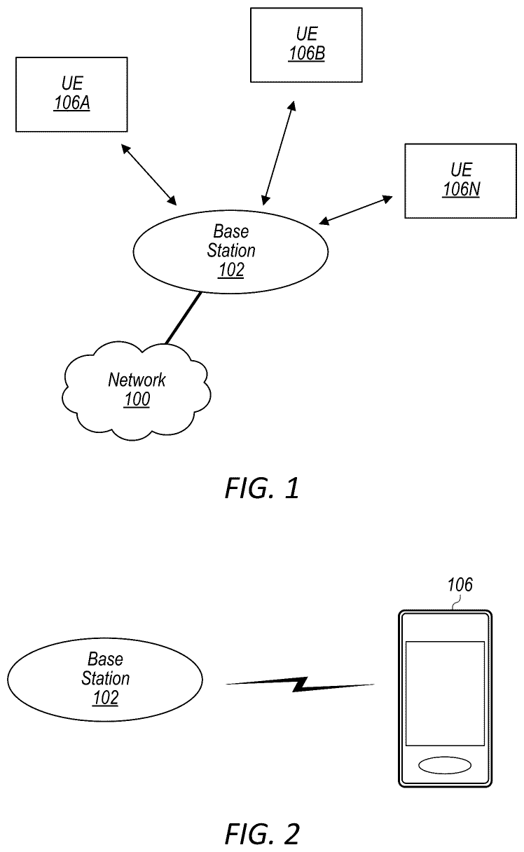

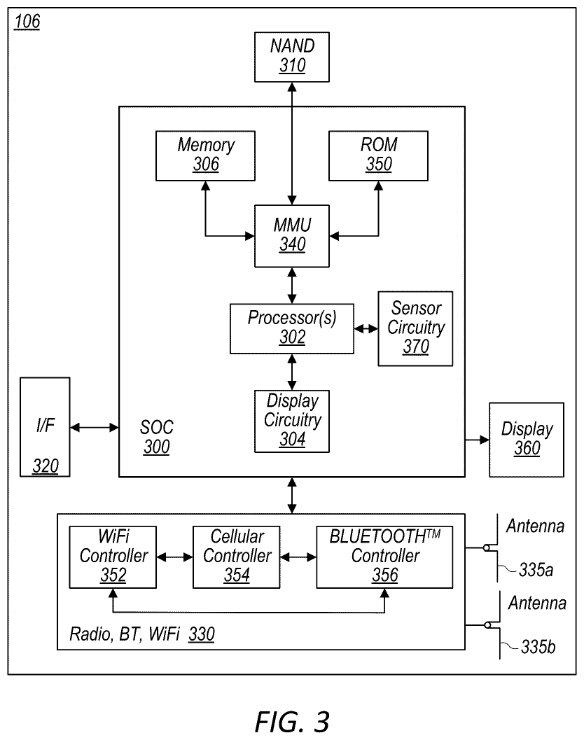

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using cither or both of a 3GPP cellular communication standard or a 3GPP2 cellular communication standard. In some embodiments, the UE 106 may be configured to perform techniques for configuring conditional handover in a non-terrestrial wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware clement such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

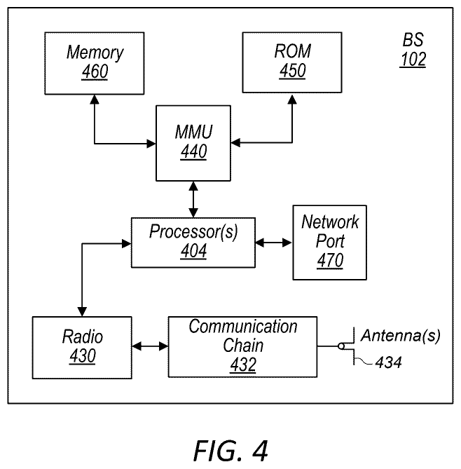

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to configure conditional handover in a non-terrestrial wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to configure conditional handover in a non-terrestrial wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

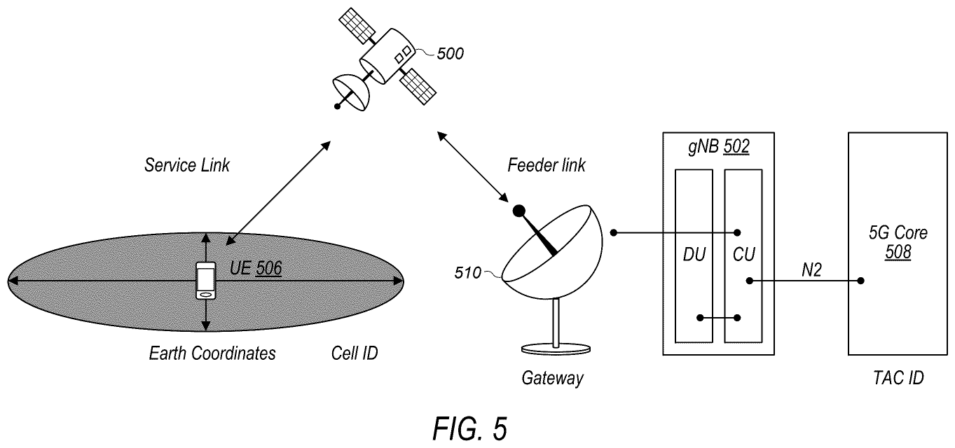

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

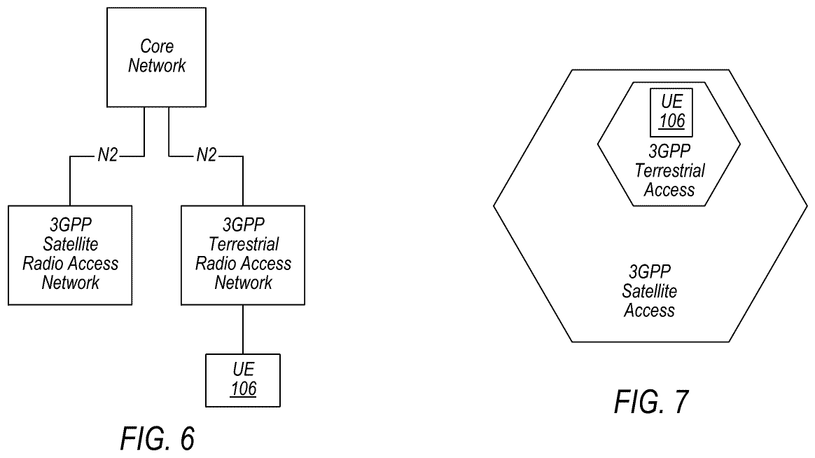

### FIGS. 5-7—3GPP Satellite Network Infrastructure

FIG. 5 is a network infrastructure diagram illustrating a 3GPP satellite network deployment, according to some embodiments. As illustrated, a satellite 500 broadcasts a service link to a UE 506, where the UE 506 is operating within a cell. The satellite 500 also conducts communications with a terrestrial gateway 510 via a feeder link, and the gateway 510 is in turn communicatively coupled to a base station 502 (e.g., a gNB). The base station 502 includes a distributed unit (DU) and a centralized unit (CU). The base station 502 is then coupled to a 5G Core Network (5GC) 508 with a tracking area code (TAC) via an N2 interface. Note that the satellite 500 may include any of various types of satellites, for example such as a geosynchronous equatorial orbit (GEO) satellite, a low earth orbit (LEO) satellite, or a medium earth orbit (MEO) satellite, among various possibilities.

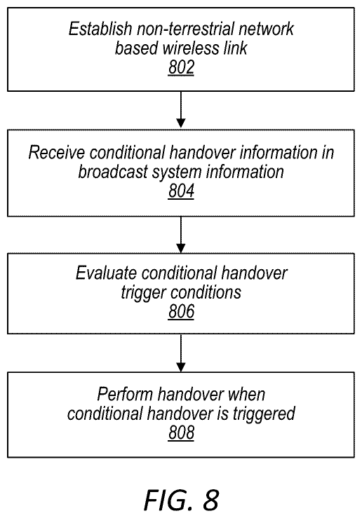

FIGS. 6-7 are schematic diagrams illustrating possible interworking between 3GPP terrestrial and satellite radio access networks (RANs), according to some embodiments. As illustrated, in FIG. 6, a UE 106 communicates with a 3GPP terrestrial RAN, e.g., through a gNB as shown in FIGS. 1-2. The 3GPP terrestrial RAN is coupled via an N2 interface with a core network, and a 3GPP satellite RAN is also coupled to the core network via the N2 interface. FIG. 7 illustrates a UE 106 operating with a cell to obtain 3GPP terrestrial access. The UE 106 also operates within a broader geographic range that provides 3GPP satellite access.

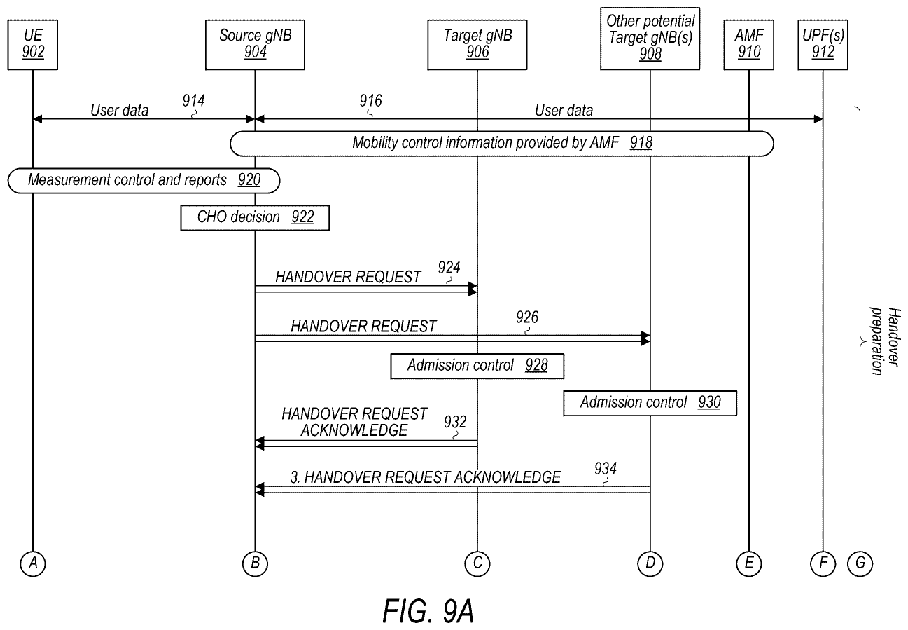

### FIG. 8—Configuring Conditional Handover in a Non-Terrestrial Network

Wireless devices operating in radio resource control (RRC) connected mode may have their mobility operations managed by the cellular network with which they are registered, e.g., by way of handover operations. In some instances, such handovers can include a serving base station providing signaling to a wireless device configuring (e.g., periodically or in an event-based manner) the wireless device to perform measurements on neighbor cells, receiving signaling including measurement reports from the wireless device based on those measurements, and providing signaling to the wireless device configuring a handover to another cell if certain handover conditions are met.

Use of such in-time signaling between a network and a device to perform handover can allow for dynamic selection of the best cell to which to perform handover at the time that handover is needed. However, such in-time signaling can sometimes lead to handover failures, e.g., as configuring handover in-time may commonly occur in relatively weak channel/signal conditions. Such scenarios may occur more commonly in fast moving conditions, in high cell density deployments in frequency ranges with high propagation loss that utilize directional transmissions (beamforming), and/or more generally in scenarios in which channel quality may degrade relatively quickly, at least according to some embodiments.

Accordingly, in some instances, conditional handover may be used, e.g., to reduce reliance on in-time RRC signaling with the source cell at the time of handover, which may make the handover more reliable. Conditional handover may include attempting to pre-deliver handover commands for a cell in advance, e.g., while conditions are good (e.g., when the device is stationary and/or has good signal quality), and allowing the device to handover later, e.g., with a reduced signaling set. Such techniques may help reduce data losses, gaps, and stalls, and may help reduce latency for wireless device handover from one cell to another. However, while the signaling required to perform such conditional handover at the time of the handover may be reduced in comparison to in-time handover signaling, if dedicated RRC signaling is used configure the conditional handover, the overall signaling load to perform the handover may be relatively substantial in both cases.

A wireless communication system that includes non-terrestrial elements, such as satellites, high altitude platforms, aircrafts, etc., may be referred to herein as a non-terrestrial network or NTN, even if one or more elements of the system are terrestrially based (as may be common.) Such a system (e.g., that could include a non-geo-stationary satellite as a relay in a wireless link between a wireless device and a cellular base station) may have potential for greater variation in relative positioning of the elements in the system relative to an entirely terrestrial system and/or a system that doesn't include a relay element. This increased potential mobility of system elements can create additional need for wireless device handovers, for example since satellite mobility (e.g., for non-geo-stationary (NGSO) satellites) can be a cause for handover to be necessary, in addition or as an alternative to wireless device mobility.

Some NTN systems may include quasi-earth fixed satellites. Such a satellite may be able to provide a serving cell to a relatively fixed or static area (e.g., a shape centered around a reference location) for a period of time by steering its antenna(s) to maintain that service area, even though the positioning of the satellite relative to the earth may be changing. After a certain amount of time (e.g., due to the change in positioning of the satellite), the antenna(s) may be re-steered to a different service area, and the satellite may then provide service to a new cell location for a next period of time. When such a service area shifts for a cell provided by such a satellite, any wireless devices that were served by the cell may need to find a new serving cell. As the timing for such shifts can be planned in advance, one approach to handling such shifts may include configuring conditional handover, with the timing of the shift in service area for a NTN cell being a possible basis for a trigger condition for the conditional handover (e.g., the conditional handover could be triggered in a period of time leading up to the service area shift, to potentially avoid service interruptions to wireless devices served by the cell after the service area shift).

At least in some instances, when such a quasi-earth fixed satellite that provides a NTN cell shifts coverage areas, handover may be precipitated for a relatively large number of wireless devices that were served by the NTN cell, potentially within a relatively short amount of time. Further, it may be possible that some or possibly even most or all of those handovers could include moving to a target NTN cell provided by the same cellular base station, which may have substantially similar configuration settings/parameters. Accordingly, it may be possible to support configuring conditional handover for multiple wireless devices in such a NTN cell using broadcast system information, e.g., instead of using dedicated (e.g., RRC) signaling to configure the conditional handover. Such an approach may potentially reduce the signaling burden for configuring conditional handover, which may increase network resource use efficiency and/or reduce wireless device power consumption, at least in some instances.

Accordingly, it may be beneficial to provide techniques for configuring conditional handover using broadcast system information in a non-terrestrial wireless communication system. To illustrate one such set of possible techniques, FIG. 8 is a flowchart diagram illustrating a method for configuring conditional handover using broadcast system information in a non-terrestrial wireless communication system, at least according to some embodiments.

Aspects of the method of FIG. 8 may be implemented by a wireless device, e.g., in conjunction with one or more cellular base stations, such as a UE 106 and a BS 102 illustrated in and described with respect to various of the Figures herein, or UE 506, satellite 500, and gNB 502 illustrated in FIG. 5, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 8 are described in a manner relating to the use of communication techniques and/or features associated with 3GPP and/or NR specification documents, such description is not intended to be limiting to the disclosure, and aspects of the method of FIG. 8 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

In 802, the wireless device may establish a wireless link with a cellular base station. According to some embodiments, the wireless link may include a cellular link according to 5G NR. For example, the wireless device may establish a session with an access and mobility function (AMF) entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

At least according to some embodiments, the wireless link may include multiple hops. For example, the wireless link may be established using one or more non-terrestrial network elements, such as a satellite, as a relay device. In such a scenario, the wireless link between the wireless device and the cellular base station may include a service link (e.g., between the wireless device and the satellite) and a feeder link (e.g., between the satellite and a cellular base station or another network element communicatively coupled with a cellular base station). Thus, the wireless device and the satellite may directly wirelessly communicate via the service link, and the satellite may relay those communications with the cellular base station via the feeder link.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, serving satellite mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 804, the wireless device may receive conditional handover information in broadcast system information. The broadcast system information may be received from the cellular base station by way of a satellite that provides a NTN cell associated with the cellular base station, at least according to some embodiments. The conditional handover information may indicate one or more conditional handover trigger conditions for one or more candidate cells.

In some instances, the broadcast system information configuring conditional handover may regularly be provided by the cellular base station, e.g., as part of its normal system information broadcast operations. In some instances, it may alternatively be possible that the broadcast system information configuring conditional handover is offered as on-demand system information, which may be transmitted by the cellular base station in response to request or inquiry from one or more wireless devices served by the cellular base station. For example, in some instances, the cellular base station may provide an indication in always-provided broadcast system information conditional handover information is available to be broadcast on-demand, but may not provide the conditional handover information itself in the broadcast system information unless it is requested. Such an approach may be beneficial, at least in some instances, in sparsely populated cells for which network transmission of conditional handover information may be unnecessary during certain times (e.g., when few or no wireless devices are served by the cell). If the wireless device is served by such a cell, the wireless device may transmit a request to the cellular base station for the conditional handover information to be broadcast, and the conditional handover information may be received by the wireless device in the broadcast system information at least in part in response to the request from the wireless device.

In some embodiments, in such a scenario, which conditional handover information is selected to be broadcast by the cellular base station may be based at least in part on the request from the wireless device. For example, it may be the case that a location specific preamble configuration is used for requesting on-demand system information, in which case the cellular base station may be able to map the system information request preamble used by the wireless device to a geographic area (e.g., GNSS coordinates and a corresponding area such as a circle, rectangle, etc.), and may select candidate cells for which to broadcast conditional handover information based at least in part on that location information (e.g., cells with service areas that overlap with the location associated with the system information request preamble, or cells within a certain distance of the location associated with the system information request preamble, as various possibilities).

At least in some instances, the candidate cell(s) for which the broadcast system information includes conditional handover information may include one or more other NTN cells associated with the same cellular base station as the NTN cell. Such cells may have substantially similar configurations (e.g., random access channel configurations, radio bearer configurations, Quality of Service Flow Indicator (QFI) to data radio bearer (DRB) mappings, etc.), and/or security keys may not change as a result of handover to such cells. In some instances, the conditional handover information may include an indication (e.g., potentially for each candidate cell for which conditional handover is configured) of whether the RRC configuration for conditional handover from the source cell to a target cell is substantially similar. If the RRC configuration for conditional handover from the source cell to a target cell is identical, it may be the case that the RRC configuration information for the target cell is not provided, e.g., since the RRC configuration information for the source cell can be re-used directly for the target cell. In some instances, if the RRC configuration for conditional handover from the source cell to a target cell is substantially similar but with some differences, it may be the case that the full RRC configuration information for the target cell is not provided, but that delta information indicating differences between RRC configurations from the source cell to the target cell is provided in the conditional handover information.

The conditional handover trigger conditions for the candidate cells may include any of a variety of possible trigger conditions, which may be configured individually or in a specific combination as an execution condition for conditional handover to a given candidate cell. For example, the conditional handover trigger conditions for a candidate cell could include any or all of a time-based triggering condition, a location-based triggering condition, or a radio resource management (RRM) measurement-based triggering condition (e.g., a reference signal received power (RSRP) based condition, a reference signal received quality (RSRQ) based condition, or a signal to noise ratio (SNR) based condition, as various possibilities), according to various embodiments. Providing the possibility for both a time-based triggering condition and a location-based triggering condition may be particularly beneficial for a conditional handover from a quasi-earth-fixed NTN source cell to another NTN cell, at least in some instances. For example, in such a scenario, the timing of the service area shift may be important to determine the timing for the handover, and the location of the wireless device may be more important to choose a good target cell for the handover than RRM measurements if there are multiple candidate NTN cells with relatively minimal variance in RRM measurements, at least in some scenarios.

In 806, the wireless device may evaluate the conditional handover trigger conditions to determine whether conditional handover is triggered for any of the candidate cells. Evaluating the conditional handover trigger conditions may include making RRM measurements (e.g., based on reference signals transmitted by the serving cell and the target cell, at least as one possibility), maintaining and monitoring system time, and/or monitoring wireless device location (e.g., based on global navigational satellite system measurements, at least as one possibility), and comparing the resulting quantities to thresholds specified by the conditional handover trigger conditions specified for each configured conditional handover.

As one example, an execution condition for conditional handover to a candidate cell could include all of a time-based triggering condition, a location-based triggering condition, and a RRM measurement-based triggering condition being fulfilled. For example, for conditional handover to the candidate cell to be triggered, it may be necessary for time to be within a certain time window specified by the time-based triggering condition (e.g., between T and T+D, where T is a start time for the triggering condition and D is a duration of the triggering condition), for the wireless device to be within a certain distance (e.g., a distance threshold specified by the location-based triggering condition) of a reference location (e.g., a reference location associated with the candidate cell), and for one or more of RSRP, RSRQ, and/or SNR for the candidate cell to meet the RRM-based triggering condition (e.g., to be better than one or more absolute thresholds and/or to be better than corresponding source cell measurements by a one or more thresholds specified by the RRM-based triggering condition). In this example, conditional handover to the candidate cell would be triggered when the combination of triggering condition configured as the execution condition are met. Thus, such an example execution condition for a conditional handover may trigger transfer of the wireless device to the candidate cell under conditions when it can be expected that the candidate cell will provide good service to the wireless device and before the current serving cell stops providing service to the wireless device, at least according to some embodiments.

Note that numerous variations on and alternatives to such an execution condition are also possible. As one possible variation, in some instances, a location-based triggering condition may be configured as an additional/separate step to evaluating whether a conditional handover is triggered. For example, it may be possible that a conditional handover is configured such that the wireless device checks its location, and only evaluates the execution condition for a candidate cell if the location of the wireless device meets the location-based triggering condition for the candidate cell (e.g., if the wireless device is within a distance of a reference location of the candidate cell configured by the location-based triggering condition). In other words, in such a scenario, the wireless device may not check whether the time or RRM conditions for conditional handover to a candidate cell are triggered if the wireless device is not within the service area of the candidate cell, at least according to some embodiments, but when the wireless device does meet the location-based triggering condition as well as the time-based triggering condition and RRM measurement-based triggering condition for a candidate cell, the conditional handover may be triggered just as it would be in the preceding example. Other variations and alternatives are also possible.

Note that there may be multiple ways of configuring the triggering condition(s) for a conditional handover. For example, for a time-based triggering condition for a quasi-earth-fixed NTN source cell, it may be possible to use an existing parameter that indicates when the cell is scheduled to shift service areas as part of a time-based triggering condition. In some instances, the cellular base station may provide an indication of such a “t-Service” parameter for the NTN based wireless link, which may indicate a time when a cell serving the wireless device stops serving its current service area.

As one possibility for using such a parameter as part of a time-based triggering condition, the cellular base station may provide an indication of a “D” parameter for the time-based triggering condition, where the D parameter indicates a time duration for which the time-based triggering condition is triggered. The wireless device may work backwards using the t-Service parameter and the D parameter to determine a “T” parameter (e.g., as t-Service−D) for the time-based triggering condition, which may indicate a start time at which the time-based triggering condition is triggered; the time-based triggering condition may thus be triggered between a time T and a time T+D in such a scenario.

As another possibility for using such a t-Service parameter as part of a time-based triggering condition, the cellular base station may directly provide a “t-Start” parameter for the time-based triggering condition, where the t-Start parameter indicates a start time at which the time-based triggering condition is triggered. In such a scenario, the time-based triggering condition may be triggered between the start time (indicated by the t-Start parameter) and the time when the cell serving the wireless device stops serving its current service area (indicated by the t-Service parameter), at least according to some embodiments.

Note that in some instances, it may be possible that the wireless device can also be configured with conditional handover information using dedicated (e.g., RRC) signaling. To account for such potential co-existence of different manners of signaling conditional handover information, it may be beneficial to provide a framework for determining which conditional handover information to prioritize. Various options are possible for such a framework. As one possibility, it may be the case that dedicated conditional handover configuration is implicitly prioritized. Thus, in such a scenario, the wireless device may determine to apply a broadcast conditional handover configuration only if it is not provided with dedicated conditional handover configuration. As another possibility, it may be the case that dedicated conditional handover configuration can be explicitly prioritized. Thus, in such a scenario, the wireless device may determine to apply a dedicated conditional handover configuration based on an explicit indication to do so even if a broadcast conditional handover configuration is provided. As a further possibility, it may be the case that broadcast conditional handover configuration can be explicitly prioritized. Thus, in such a scenario, the network may broadcast an indication of when the broadcast conditional handover configuration can be used, and the wireless device may determine to apply the broadcast conditional handover configuration based on the explicit indication to do so even if provided with a dedicated conditional handover configuration. As yet another possibility, it may be the case that both dedicated and broadcast conditional handover configuration can be used; for example, for candidate cells not present in dedicated conditional handover configuration but present in broadcast conditional handover configuration, the broadcast conditional handover configuration may be used, while for candidate cells not present in broadcast conditional handover configuration but present in dedicated conditional handover configuration, the dedicated conditional handover configuration may be used. In such a scenario, for candidate cells present in both dedicated and broadcast conditional handover configuration, one of the preceding frameworks for prioritizing the dedicated or broadcast conditional handover configuration may be used. Note that if the network prefers to implicitly prioritize broadcast conditional handover configuration, the network may be able to simply not provide dedicated conditional handover configuration, at least according to some embodiments.

In 808, the wireless device may perform handover to a candidate cell when conditional handover to the candidate cell is triggered. Once a candidate cell has been selected for handover, that cell may also be referred to as the “target cell” of the handover. Performing handover to the target cell may include performing any of a variety of possible procedures to coordinate with the target cell and the source cell to transfer service for the wireless device to the target cell. In some instances, this may at least include performing a random access channel (RACH) procedure with the target cell.

If desired, it may be possible that the conditional handover information received in the broadcast system information further includes RACH configuration information for conditional handover. Such RACH configuration information may be configured to help facilitate a smoother handover transition from the source cell to the target cell. In some instances, the RACH configuration information may be designed at least in part to mitigate the impact of a “RACH storm” scenario that could potentially occur when a quasi-earth-fixed NTN cell changes service areas, e.g., if the change in service area for the cell would trigger handover for a large number of wireless devices that were served by the cell. For example, the RACH configuration information may be used to split wireless devices served by the source cell into different groups that can use different RACH resources and/or perform handover at different times, which may potentially reduce the likelihood of RACH failures for the wireless device attempting to perform handover from the source cell.

The RACH configuration information could include any of various possible types of information. Some possibilities may include a set of preambles configured for use for RACH transmissions for conditional handover, a time duration within which a wireless device is configured to perform random access after a conditional handover is triggered, an indication of which wireless device identity information to use to determine a set of RACH resources available to the wireless device for RACH transmissions for conditional handover, and/or an indication of RACH opportunities configured for use for RACH transmissions for conditional handover.

The wireless device identity information used to determine the set of RACH resources available to the wireless device for RACH transmissions for conditional handover may include any of various types of wireless device identity information, such as a cell radio network temporary identifier (C-RNTI), 5G identity information (e.g., 5G shortened temporary mobile subscriber identity or 5G-S-TMSI), or even a random ID generated by the wireless device. RACH resources (e.g., preambles and/or RACH opportunities) can be grouped into different sets, where use of the resources in a set of resources is limited to wireless devices that belong to the set (e.g., based on their wireless device identity information).

Thus, at least according to some embodiments, the method of FIG. 8 may be used to provide a framework according to which conditional handover can be efficiently and effectively be configured in a non-terrestrial wireless communication system, at least in some instances.

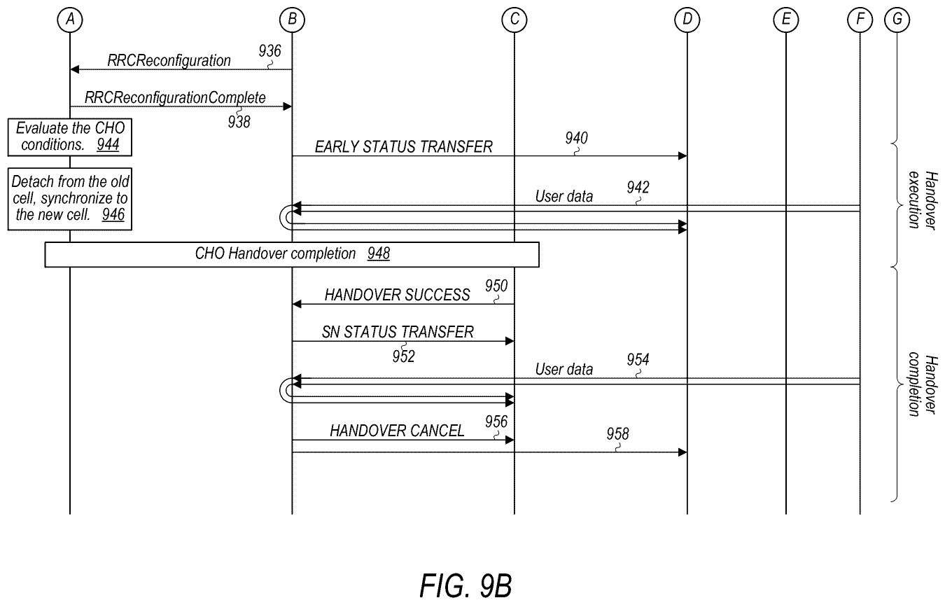

### FIGS. 9A-9B and Additional Information

FIGS. 9A-9B and the following additional information illustrate and describe further aspects that might be used in conjunction with the method of FIG. 8 if desired. It should be noted, however, that the exemplary details described in the following section are not intended to be limiting to the disclosure as a whole: numerous variations and alternatives to the details provided herein below are possible and should be considered within the scope of the disclosure.

Conditional handover (CHO) is a feature that can be used to potentially improve mobility robustness in a cellular communication system. CHO may include configuring a UE with a handover command and one or more associated conditions to monitor. The UE may be able to execute the stored handover command when the associated condition(s) become true. Such pre-configuration of handover under certain conditions may avoid or reduce the likelihood of failure due to the measurement report from the UE or the handover command from the network not being received in a conventional handover. CHO can be used in terrestrial as well as non-terrestrial network deployment scenarios. For NR NTN, it may be possible to define conditional trigger conditions related to location and time. In some embodiments, at most 2 measurement triggering conditions may be configured per execution condition, and dedicated RRC configuration may be used to configure the UE to perform CHO. FIGS. 9A-9B illustrate signal flow aspects of an exemplary such dedicated signaling scheme for configuring conditional handover for a wireless device, according to some embodiments.

As shown, in the illustrated scenario, a UE 902 may be attached to a source gNB 904, while a potential target gNB 906 and other potential target gNBs 908 are also deployed in the system. The network may also include an AMF 910 and one or more user plane functions (UPFs) 912. In 914, the UE 902 may exchange user data with the source gNB 904, which in 916 may exchange user data with the UPF(s) 912. In 918, mobility control information may be provided by the AMF 910. In 920, the source gNB 904 may perform measurement control and receive measurement reporting from the UE 902. In 922, the source gNB 904 may make a CHO decision, e.g., to decide to configure the UE 902 to perform CHO. In 924, the source gNB 904 may provide a handover request to the target gNB 906, and in 926, the source gNB 904 may similarly provide a handover request to the other potential target gNBs 908 (e.g., if applicable). In 928 and 930, the target gNB 906 and other potential target gNBs 908, respectively, may perform admission control, and in 932 and 934, the target gNB 906 and other potential target gNBs 908, respectively, may provide handover request acknowledge messages to the source gNB 904.

In 936, the source gNB 904 may provide a RRC reconfiguration message to the UE 902, which may include CHO configuration information. In 938, the UE 902 may provide a RRC reconfiguration complete message to the source gNB 904. In 940, the source gNB 904 may provide an early status transfer to a potential target gNB 908, and in 942, the UPF 912 may transfer user data to the potential target gNB 908 via the source gNB 904. In 944, the UE 902 may evaluate the CHO conditions. In 946, the UE may detach from the old cell, and may synchronize to the new cell, which may be the target gNB 906 in the illustrated example. In 948, the source gNB 904, UE 902, and target gNB 906 may perform CHO handover completion. In 950, the target gNB 906 may indicate to the source gNB 904 that handover is successful, and in 952, the source gNB 904 may provide sequence number status transfer to the target gNB 906. In 954, the UPF 912 may transfer user data to the target gNB 906 via the source gNB 904. In 956 and 958, the source gNB 904 may provide a handover cancel indication to the target gNB 906 and any other potential target gNBs 908, respectively, to inform them that the conditional handover configuration is no longer valid. Further possible subsequent steps that could be used in conjunction with such CHO operation, at least according to some embodiments, are illustrated in 3GPP TS 38.300 v.17.0.0 FIG. 9.2.3.2.1-1 steps 9-12.

At least in some instances, NTN cells can be relatively large and can accordingly provide coverage to a potentially large number of UEs. Dedicated CHO configuration may incur a relatively large signaling burden, even while the parameters that the network configures (time and/or location) may be mostly similar or the same for multiple UEs of a NTN cell, at least in some scenarios. Additionally, satellite mobility can potentially induce a relatively large number of simultaneous (or near simultaneous) handovers. For example, in some scenarios, a non-geo-stationary (NGSO) quasi-earth fixed satellite may have steerable antennas that cover the same area for a period of time, then may change its steering angle to cover a different area for a period of time. Such a transition may break the service link between the satellite (which may also be referred to as the NTN payload, in some instances) and the UEs served. A large number of UEs being forced to perform handover over a short period of time, such as could occur in this example scenario, could result in overburdening of random access channel (RACH) resources used to perform those handovers. Such a circumstance may also be referred to as a “RACH storm,” at least in some instances, and can have the potential to result in handover failure for at least some of those UEs.

Accordingly, it may be beneficial to introduce techniques that can reduce the signaling overhead of conditional handovers, and/or that can help prevent the occurrence of RACH storms, at least in some embodiments. For example, it may be beneficial to provide such techniques for use in NTN cellular systems, in which the gNB may be ground based, and potentially multiple different satellites (NTN payloads) can effectively provide cells that belong to the same gNB. Note that it may also be possible for a satellite to switch feeder-links to associate with a different gNB. Thus, for a set of satellites that belong to the same gNB, it may be possible that when handover is configured for a UE, the UE RRC configuration in the source and target cells may typically be the same or nearly the same, e.g., including RACH configuration, radio bearer configuration, QFI-to-DRB mapping, etc. The security keys may not change as a result of such a handover.

In such a scenario, it may be possible to broadcast CHO configuration information in system information, e.g., instead of or in addition to using dedicated RRC signaling. The broadcast CHO configuration can use similar parameters as in CHO configuration using dedicated RRC signaling; for example, the gNB may broadcast MeasConfig and ConditionalReconfiguration IEs corresponding to a list of candidate cells along with associated execution conditions. Time and location based conditional triggering conditions can be used for the execution conditions. The MeasConfig and ConditionalReconfiguration IEs can be broadcast in an existing system information block (SIB), such as a NTN specific SIB (e.g., SIB 19) or a new SIB. A new SIB may be used to ensure that the maximum system information size (e.g., 2976 bits, as one possibility) is not exceeded. Alternatively, if an existing SIB is used, the SIB can be subject to segmentation, if desired.

To provide at least some configuration flexibility to the network, in some instances, the gNB may be able to broadcast an indication for whether the target and source RRC configurations are substantially similar. In such a scenario, the broadcast CHO configuration may not contain any target RRC reconfiguration information (e.g., if the RRC configurations are identical). As another possibility, delta signaling can be used to indicate differences between the source cell RRC configuration and the target cell RRC configuration. In some instances, a change in SIB content related to the CHO configuration need not trigger system information modification notification, e.g., at least for quasi-earth-fixed (NGSO) satellites. For example, such notifications may be considered unnecessary due to the amount of time that a UE may typically remain connected to such a cell (e.g., a few minutes, as one possibility).

The network may be aware of satellite constellation ephemeris. It may be the case that only UEs in a certain geographic location need to handoff to a particular NTN cell. In some instances, it may be the case that RRM measurements (e.g., reference signal received power (RSRP), reference signal received quality (RSRQ), signal to noise ratio (SNR)) do not significantly vary across candidate NTN cells, so may not be of primary importance to identify a target NTN cell. It may be beneficial in an NTN deployment scenario to use location and time together as part of conditional handover triggering. Thus, there may be benefit to allowing more than 2 trigger conditions for conditional handover, at least in some embodiments.

For example, in some instances, it may be possible to allow a location-based trigger condition as an additional (third) condition for CHO execution. Thus, both location (e.g., CondEvent D1) and time (CondEvent T1) to be configured together with a RRM measurement (e.g., CondEvent A3, A4, or A5). As another possibility, an additional location-based trigger condition may be configured such that the execution condition for a candidate cell is only considered if the UE is within some distance of the reference location of the candidate cell (e.g., CondEvent D2: Distance between UE and a reference location referenceLocation1 becomes less than configured threshold Thresh1; where referenceLocation1 denotes the reference location of the candidate cell).

For time based conditional event triggering, as one possibility, the network may configure a time threshold (T) and duration (D). The event may be considered triggered between time T and T+D, in such a scenario. Each NTN cell (quasi-earth-fixed case), may also be associated with a parameter “t-Service”. This parameter may indicate the time information for when a cell provided via the NTN quasi-earth-fixed system is going to stop serving the area it is currently serving. \

A conditional event may be defined to ensure that CHO is triggered at least D units of time before the UE loses coverage from the serving cell. As one option, the network may configure a parameter D for the conditional event. The UE may determine T as T=t-Service−D, and the event may be considered triggered between the time T and T+D. As another option, the network may configure a parameter t-Start for the conditional event, and the event may be considered triggered between the time t-Start and t-Service. In some instances, it may be possible that the latter option can provide finer granularity (e.g., the unit of time threshold and t-Service may be 10 ms, while the duration parameter D may be configured in units of 100 ms, in some embodiments). The CHO execution conditions may be determined by the source gNB.

In some instances, it may be possible for a SIB providing CHO configuration to be an on-demand SIB, e.g., if a new SIB is used to provide the CHO configuration information. Such a provision can be useful in sparsely populated cells, in which network transmission requirements may thereby be reduced during times when the SIB providing CHO configuration does not need to be transmitted. The network may be able to indicate the existence of broadcast CHO in another SIB (e.g., SIB 19, as one possibility), for example as part of SchedulingInfo. UEs can then initiate on-demand delivery of the new SIB.

In some instances, location specific preamble configuration can be used for on-demand SIB based CHO configuration. SI request preambles can be mapped to geographic areas (e.g., GNSS coordinates and corresponding area (circular, rectangular, etc.) with shape specific parameters. By mapping preambles to geographic area, the network may be able to determine the candidate cells to consider for broadcast CHO, at least according to some embodiments.

As previously noted herein, it may be possible for such broadcast CHO configuration to be implemented alongside CHO configuration using dedicated signaling. It may be useful to provide a mechanism for the network to control when such broadcast CHO configuration is applied by a UE, and also manage how broadcast CHO configuration and dedicated CHO configuration can co-exist. As a first option, dedicated CHO configuration may be implicitly prioritized. Thus, a UE may apply a broadcast CHO configuration only if it is not provided with dedicated CHO configuration in such a scenario, at least according to some embodiments. As a second option, dedicated CHO configuration may be explicitly prioritized. Thus, a UE may apply a dedicated CHO configuration based on an explicit indicate to do so, even if broadcast CHO configuration is available in such a scenario, at least according to some embodiments. As a third option, broadcast CHO configuration may be explicitly prioritized. Thus, the network may broadcast an indication of when broadcast CHO can be used, and the UE may apply the broadcast CHO configuration even if provided with dedicated CHO configuration in such a scenario, at least according to some embodiments. As a still further possibility, both dedicated and broadcast CHO configuration may be used, such that for candidate cells not present in dedicated CHO configuration but present in broadcast CHO configuration, the broadcast CHO configuration may be used, while for candidate cells not present in broadcast CHO configuration but present in dedicated CHO configuration, the dedicated CHO configuration may be used, and for candidate cells present in both broadcast CHO configuration and in dedicated CHO configuration, one of the first, second, or third option described previously may be used to determine which CHO configuration to use. Note that it may be the case that the option of implicitly prioritizing broadcast CHO configuration may not be needed, since in such a scenario the network may be able to not provide dedicated CHO configuration.

As previously noted herein, having a large number of UEs executing handover at the same time can lead to a RACH storm. Such a scenario may be particularly likely when the UEs are following the same broadcast CHO configuration. Accordingly, it may be beneficial to provide techniques for prioritizing and randomizing the RACH attempts by the UEs for handovers such as to reduce the likelihood for a RACH storm and widespread handover failure. The system information for broadcasting CHO configuration information can also contain RACH configuration information that can be used for CHO purposes, which may be used to mitigate the likelihood of the broadcast CHO configuration causing a RACH storm. For example, the RACH configuration can include a set of preambles to be used for RACH purposes, a time duration (“T_{exec}”) during which the UE is required to perform random access after a CHO execution condition is triggered, an indication of what identity the UE should use (e.g., for randomization purposes), and an indication of which RACH opportunities can be used for broadcast CHO (e.g., as a PRACH configuration index), as one possibility. Variations on such RACH configuration information, such as inclusion of additional RACH configuration information or alternative RACH configuration information, are also possible. According to some embodiments, if no such RACH configuration is provided in the system information, the UE may execute the RACH in a normal or default manner.

Thus, depending on the RACH configuration for broadcast CHO, a UE may be able to randomly choose both a RACH preamble and RACH occasion to use. It may be assumed that all NTN cells that belong to a certain gNB use the same RACH configuration for broadcast CHO, in some embodiments. The RACH occasion can be chosen randomly from the RACH opportunities available within T_{exec} of the CHO execution triggering instant. To manage the potential for collisions, the RACH resources can be grouped into different sets, and only UEs that belong to a set may use the RACH resources (preambles and/or RACH occasions) for the set. Several parameters can be used to classify UEs into different sets; for example, C-RNTI, 5G identity (e.g., 5G-S-TMSI), and/or a random ID generated by the UE may be used, according to various embodiments.

In the following further exemplary embodiments are provided.

One set of embodiments may include a method, comprising: by a wireless device: establishing a non-terrestrial network (NTN) based wireless link with a cellular base station; receiving conditional handover information in broadcast system information, wherein the conditional handover information indicates one or more conditional handover trigger conditions for one or more candidate cells; evaluating the one or more conditional handover trigger conditions to determine whether conditional handover is triggered for the one or more candidate cells; and performing handover to a candidate cell when conditional handover to the candidate cell is triggered.

According to some embodiments, the conditional handover information includes an indication of whether radio resource control (RRC) configurations for conditional handover from a source cell to a target cell are substantially similar.

According to some embodiments, the conditional handover information further includes delta information indicating differences between RRC configurations for conditional handover from the source cell to the target cell.

According to some embodiments, the one or more conditional handover trigger conditions include one or more of: a time-based triggering condition; a location-based triggering condition; or a radio resource management (RRM) measurement-based triggering condition.

According to some embodiments, the method further comprises: determining a location of the wireless device, wherein the one or more conditional handover trigger conditions are evaluated to determine whether conditional handover is triggered for the one or more candidate cells based at least in part on the location of the wireless device.

According to some embodiments, the one or more conditional handover trigger conditions include at least a time-based triggering condition, wherein the method further comprises: receiving an indication of a “t-Service” parameter for the NTN based wireless link, wherein the t-Service parameter indicates a time when a cell serving the wireless device stops serving its current service area; receiving a “D” parameter for the time-based triggering condition, wherein the D parameter indicates a time duration for which the time-based triggering condition is triggered; determining a “T” parameter for the time-based triggering condition, wherein the T parameter indicates a start time at which the time-based triggering condition is triggered, wherein the T parameter is determined as t-Service−D; wherein the time-based triggering condition is triggered between a time T and a time T+D.

According to some embodiments, the one or more conditional handover trigger conditions include at least a time-based triggering condition, wherein the method further comprises: receiving an indication of a “t-Service” parameter for the NTN based wireless link, wherein the t-Service parameter indicates a time when a cell serving the wireless device stops serving its current service area; and receiving a “t-Start” parameter for the time-based triggering condition, wherein the t-Start parameter indicates a start time at which the time-based triggering condition is triggered, wherein the time-based triggering condition is triggered between the start time indicated by the t-Start parameter and the time when the cell serving the wireless device stops serving its current service area indicated by the t-Service parameter.

According to some embodiments, the method further comprises: receiving an indication in broadcast system information that the conditional handover information is available to be broadcast on-demand; and transmitting a request to the cellular base station for the conditional handover information to be broadcast.

According to some embodiments, the method further comprises: receiving conditional handover information in dedicated signaling; and determining whether to prioritize the conditional handover information received in dedicated signaling or the conditional handover information received in broadcast system information.

According to some embodiments, the conditional handover information received in broadcast system information further includes random access channel (RACH) configuration information for conditional handover, wherein the RACH configuration information for conditional handover includes one or more of: a set of preambles configured for use for RACH transmissions for conditional handover; a time duration within which a wireless device is configured to perform random access after a conditional handover is triggered; an indication of which wireless device identity information to use to determine a set of RACH resources available to the wireless device for RACH transmissions for conditional handover; or an indication of RACH opportunities configured for use for RACH transmissions for conditional handover.

Another set of embodiments may include a wireless device, comprising: one or more processors; and a memory having instructions stored thereon, which when executed by the one or more processors, perform steps of any of the methods of the preceding examples.

Yet another set of embodiments may include a computer program product, comprising computer instructions which, when executed by one or more processors, perform steps of any of the methods of the preceding examples.

Still another set of embodiments may include a method, comprising: by a cellular base station: establishing a non-terrestrial network (NTN) based wireless link with a wireless device; and providing conditional handover information in broadcast system information, wherein the conditional handover information indicates one or more conditional handover trigger conditions that trigger handover to one or more candidate cells.

According to some embodiments, the conditional handover information includes an indication that radio resource control (RRC) configurations for conditional handover from a source cell to a candidate cell are substantially similar, wherein the conditional handover information further includes delta information indicating differences between RRC configurations for conditional handover from the source cell to the candidate cell.

According to some embodiments, the one or more conditional handover trigger conditions include: a time-based triggering condition; a location-based triggering condition; and a radio resource management (RRM) measurement-based triggering condition.

According to some embodiments, the method further comprises: providing an indication in broadcast system information that the conditional handover information is available to be broadcast on-demand; and receiving a request from the wireless device for the conditional handover information to be broadcast, wherein the conditional handover information is provided in the broadcast system information based at least in part on the request for the conditional handover information to be broadcast.

According to some embodiments, the request for the conditional handover information to be broadcast indicates location information for the wireless device, wherein candidate cells are selected for the conditional handover information based at least in part on the location information for the wireless device.

According to some embodiments, the conditional handover information provided in broadcast system information further includes random access channel (RACH) configuration information for conditional handover.

A further set of embodiments may include a cellular base station, comprising: one or more processors; and a memory having instructions stored thereon, which when executed by the one or more processors, perform steps of any of the methods of the preceding examples.

A still further set of embodiments may include a computer program product, comprising computer instructions which, when executed by one or more processors, perform steps of any of the methods of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
communication via a non-terrestrial network (NTN) based wireless link with a cellular base station;
receiving conditional handover information in broadcast system information, wherein the conditional handover information indicates one or more conditional handover trigger conditions for one or more candidate cells;
evaluating the one or more conditional handover trigger conditions to determine whether conditional handover is triggered for the one or more candidate cells; and
performing handover to a candidate cell when conditional handover to the candidate cell is triggered.

2. The method of claim 1,
wherein the conditional handover information includes an indication of whether radio resource control (RRC) configurations for conditional handover from a source cell to a target cell are substantially similar.

3. The method of claim 2,
wherein the conditional handover information further includes delta information indicating differences between RRC configurations for conditional handover from the source cell to the target cell.

4. The method of claim 1, wherein the one or more conditional handover trigger conditions include one or more of:
a time-based triggering condition;
a location-based triggering condition; or
a radio resource management (RRM) measurement-based triggering condition.

5. The method of claim 1, wherein the method further comprises:
determining a location of the wireless device,
wherein the one or more conditional handover trigger conditions are evaluated to determine whether conditional handover is triggered for the one or more candidate cells based at least in part on the location of the wireless device.

6. The method of claim 1, wherein the one or more conditional handover trigger conditions include at least a time-based triggering condition, wherein the method further comprises:
receiving an indication of a “t-Service” parameter for the NTN based wireless link, wherein the t-Service parameter indicates a time when a serving cell stops serving its current service area;
receiving a “D” parameter for the time-based triggering condition, wherein the D parameter indicates a time duration for which the time-based triggering condition is triggered; and
determining a “T” parameter for the time-based triggering condition, wherein the T parameter indicates a start time at which the time-based triggering condition is triggered, wherein the T parameter is determined as t-Service−D;
wherein the time-based triggering condition is triggered between a time T and a time T+D.

7. The method of claim 1, wherein the one or more conditional handover trigger conditions include at least a time-based triggering condition, wherein the method further comprises:
receiving an indication of a “t-Service” parameter for the NTN based wireless link, wherein the t-Service parameter indicates a time when a serving cell stops serving its current service area; and
receiving a “t-Start” parameter for the time-based triggering condition, wherein the t-Start parameter indicates a start time at which the time-based triggering condition is triggered,
wherein the time-based triggering condition is triggered between the start time indicated by the t-Start parameter and the time when the cell serving the wireless device stops serving its current service area indicated by the t-Service parameter.

8. The method of claim 1, wherein the method further comprises:
receiving an indication in broadcast system information that the conditional handover information is available to be broadcast on-demand; and
transmitting a request to the cellular base station for the conditional handover information to be broadcast.

9. The method of claim 1, wherein the method further comprises:
receiving conditional handover information in dedicated signaling; and
determining whether to prioritize the conditional handover information received in dedicated signaling or the conditional handover information received in broadcast system information.

10. The method of claim 1,
wherein the conditional handover information received in broadcast system information further includes random access channel (RACH) configuration information for conditional handover, wherein the RACH configuration information for conditional handover includes one or more of:
a set of preambles configured for use for RACH transmissions for conditional handover;
a time duration within which a wireless device is configured to perform random access after a conditional handover is triggered;
an indication of which wireless device identity information to use to determine a set of RACH resources available for RACH transmissions for conditional handover; or
an indication of RACH opportunities configured for use for RACH transmissions for conditional handover.

11.-20. (canceled)

21. A method, comprising:
by a cellular base station:
establishing a non-terrestrial network (NTN) based wireless link with a wireless device; and
providing conditional handover information in broadcast system information, wherein the conditional handover information indicates one or more conditional handover trigger conditions that trigger handover to one or more candidate cells.

22. The method of claim 21,
wherein the conditional handover information includes an indication that radio resource control (RRC) configurations for conditional handover from a source cell to a candidate cell are substantially similar,
wherein the conditional handover information further includes delta information indicating differences between RRC configurations for conditional handover from the source cell to the candidate cell.

23. The method of claim 21, wherein the one or more conditional handover trigger conditions include:
a time-based triggering condition;
a location-based triggering condition; and
a radio resource management (RRM) measurement-based triggering condition.

24. The method of claim 21, wherein the method further comprises:
providing an indication in broadcast system information that the conditional handover information is available to be broadcast on-demand; and
receiving a request from the wireless device for the conditional handover information to be broadcast,
wherein the conditional handover information is provided in the broadcast system information based at least in part on the request for the conditional handover information to be broadcast.

25. The method of claim 21,
wherein the request for the conditional handover information to be broadcast indicates location information for the wireless device,
wherein candidate cells are selected for the conditional handover information based at least in part on the location information for the wireless device.

26. The method of claim 21, wherein the conditional handover information provided in broadcast system information further includes random access channel (RACH) configuration information for conditional handover.

27. An apparatus, comprising:
a processor configured to, when executing instructions stored in a memory, perform operations comprising:
communicating via a non-terrestrial network (NTN) based wireless link with a cellular base station;
receiving conditional handover information in broadcast system information, wherein the conditional handover information indicates one or more conditional handover trigger conditions for one or more candidate cells;
evaluating the one or more conditional handover trigger conditions to determine whether conditional handover is triggered for the one or more candidate cells; and
performing handover to a candidate cell when conditional handover to the candidate cell is triggered.

28. The apparatus of claim 25,
wherein the conditional handover information includes an indication of whether radio resource control (RRC) configurations for conditional handover from a source cell to a target cell are substantially similar.

29. The apparatus of claim 25, wherein the one or more conditional handover trigger conditions include one or more of:
a time-based triggering condition;
a location-based triggering condition; or
a radio resource management (RRM) measurement-based triggering condition.

30. The apparatus of claim 25, the operations further comprising:
determining a location of the wireless device, wherein the one or more conditional handover trigger conditions are evaluated to determine whether conditional handover is triggered for the one or more candidate cells based at least in part on the location of the wireless device.
